(19) United States
(12) Patent Application Publication
(10) Pub. No.: US 2012/0085322 A1
(43) Pub. Date: Apr. 12, 2012

(54) Internal Combustion Engine as well as Retrofitting/Conversion Kit for such an Internal Combustion Engine

(76) Inventor: Alfred Trzmiel, Nurtingen (DE)

(21) Appl. No.: 13/271,257

(22) Filed: Oct. 12, 2011

(30) Foreign Application Priority Data
Oct. 12, 2010 (DE) 10 2010 048 910.7

(51) Int. Cl. F02D 19/08; F02M 61/14

(52) U.S. Cl. 123/470; 123/434; 123/445

(57) ABSTRACT

An internal combustion engine with combustion chambers into which liquid and gaseous fuel is introduced together with intake air is operated, at least predominantly, with only one type of fuel in a range in which a harmful HC excess is produced by internal combustion. A retrofitting/conversion kit for such an internal combustion engine has at least one securing plate for at least one injection nozzle for gaseous fuel, wherein a supply conduit for the gaseous fuel is connectable to the at least one injection nozzle, wherein the at least one securing plate is an intermediate flange to be connected between a cylinder head of the internal combustion engine and an intake manifold of the internal combustion engine.

### BACKGROUND OF THE INVENTION

The invention concerns an internal combustion engine with combustion chambers into which liquid and gaseous fuel together with intake air is introduced, as well as a retrofitting/conversion kit for such an internal combustion engine.

Internal combustion engines are known that are operated with liquid fuel_{;} for example, gasoline or diesel fuel, and gaseous fuel.

The invention has the object to configure the combustion engine of the aforementioned kind as well as the retrofitting/conversion kit of the aforementioned kind in such a way that a cost-saving operation with only minimal emissions is ensured,

### SUMMARY OF THE INVENTION

This object is solved according to the invention for the internal combustion engine of the aforementioned kind in that the internal combustion engine in the range in which a harmful HC excess is produced is at least predominantly operated with only one type of fuel.

In regard to the retrofitting/conversion kit of the aforementioned kind this object is solved according to the invention in that it comprises at least one securing plate for at least one injector nozzle for gaseous fuel to which can be connected a supply conduit for the gaseous fuel and in that the securing plate is embodied as an intermediate flange between a cylinder head of the internal combustion engine and the intake manifold.

The internal combustion engine according to the invention is characterized in that in normal operation it is operated with a mixture of gaseous and liquid fuel. However, as soon as during operation a harmful HC excess occurs, the internal combustion engine is operated with only one type of fuel, or at least predominantly with only one type of fuel inasmuch as minimal undisturbing additives of another fuel type are used. In case of a diesel engine, in this situation only or predominantly only diesel fuel is used. In case of an Otto-cycle engine, gasoline or the gaseous fuel can be used selectively alone or predominantly alone in order to adjust the HC values to the permissible value range. In order to detect this HC excess, for example, sensors can be used that detect the HC values in the exhaust gas of the internal combustion engine and supply the measured values as signals to a control unit. With it, a control or regulation is done in such a way that the HC values in the exhaust gas will reach again a permissible range. Subsequently, the control unit adjusts again a mixed operation in which the internal combustion engine is operated with a mixture of liquid and gaseous fuel,

The term gaseous fuel is to be understood as only one type of g as well as a mixture of at least two gases.

Advantageously, the operation is realized with only one or at least predominantly only one type of fuel during starting and/or at idle of the internal combustion engine. In this connection, preferably liquid fuel is used.

In full load operation, increased HC values may occur also so that also in this range he internal combustion engine is advantageously operated with only one or at least predominantly with only one type of fuel. However, it is also possible to employ liquid and gaseous fuel in full load operation. In this way, the efficiency and also the performance of the internal combustion engine can be increased,

Finally, it is also possible to switch to a single-fuel operation when the internal combustion engine operates in the transient range. Single-fuel operation means that preferably only one type of fuel is used. In this case, minimal undisturbing additives of another type of fuel can be used also. The internal combustion engine is then, at least predominantly, still operated with only one type of fuel.

The internal combustion engine, in case of diesel fuel as a liquid fuel, is advantageously exclusively or at least predominantly exclusively operated with diesel fuel in the range in which a harmful HC excess is produced.

When the internal combustion engine is an Otto-cycle engine, advantageously gasoline or the gaseous fuel is used as the only or at least predominantly as the only fuel in the range in which a harmful HC excess is produced in mixed operation.

In an advantageous embodiment, the liquid or gaseous fuel is injected eccentrically near the inlet valve into an intake pipe or into an intake channel.

In case of a diesel engine, the gaseous fuel is injected eccentrically by means of an injector nozzle near the inlet valve into the intake pipe or into the intake channel. Upon opening of the inlet valve, the gas/air mixture is sucked into the combustion chamber. As soon as the compression begins, the diesel fuel is injected and everything ignites.

In an Otto-cycle or gasoline engine the injection of the liquid fuel into the intake pipe is realized near the inlet valve. The liquid fuel/air mixture flows upon opening of the inlet valve into the combustion chamber. The gaseous fuel is directly injected by means of at least one gas nozzle provided in the cylinder head directly into the combustion chamber.

Advantageously, the injection pressure of the gaseous fuel is adjustable by means of at least one pressure control valve to all operating states. In this way, it is possible to control the injection pressure dependent on load and/or emissions and/or engine speed.

The retrofitting/conversion kit according to the invention enables retrofitting of existing internal combustion engines in a simple way. Only the existing intake manifold is removed and the securing plate is inserted between the cylinder heads of the internal combustion engine and the intake manifold. The securing plate comprises the injector nozzles for the gaseous fuel to which are connectable the supply conduits. It is also possible that the supply conduits are already connected to the injector nozzles.

Further features of the invention result from the further claims, the description and the drawings.

### BRIEF DESCRIPTION OF THE DRAWINGS

The invention will be explained in more detail in the following with the aid of two embodiments illustrated in the drawings. It is shown in;

FIG. 1 in schematic illustration a device according to the invention;

FIG. 2 in an illustration corresponding to FIG. 1 a second embodiment of a device according to the invention;

FIG. 3 in a schematic illustration an intake pipe into which an injector nozzle for the gaseous fuel projects eccentrically;

FIG. 4 in a plan view the eccentric injection of the gaseous fuel into the intake pipe of the device according to the invention;

FIG. 5 in schematic illustration a retrofitting/conversion kit according to the invention.

### DESCRIPTION OF PREFERRED EMBODIMENTS

With the devices to be disclosed in the following it is possible to operate in internal combustion engine 1 with liquid fuel, with a mixture of a liquid and a gaseous fuel or a mixture of different gases or a gaseous fuel. In the following, one embodiment is disclosed in which a liquid and a gaseous fuel are used. The invention is however not limited to this embodiment.

Advantageously, the internal combustion engine 1 is a diesel engine that, depending on the configuration, has an appropriate number of cylinders with combustion chambers into which the fuel is injected, respectively. The liquid fuel, preferably diesel fuel, is contained in a tank 2 from which the fuel is injected, as is known in the art, through valves 3 into the combustion chambers, respectively. The exhaust gases that are produced in the combustion chambers pass into an exhaust gas conduit 4 through which the exhaust gases, via a catalyst 6 and/or a diesel particulate filter and an exhaust conduit 7 are guided to the exhaust. The catalyst 6 is connected to the exhaust gas conduit 4 by conduit 5.

In addition, the combustion chambers of the internal combustion engine 1 can be supplied with a gaseous fuel which is contained in gas tank 9. Natural gas, methane, hydrogen, liquid gas, biogas, and other known gases can be used as gaseous fuel. The gas tank 9 is connected by means of supply conduit 10 to a common rail 11 by means of which the gaseous fuel with the aid of injector nozzles 12 are admixed to the intake air and, in this way, are supplied into the combustion chambers of the internal combustion engine 1. In the supply conduit 10 a pressure control valve 13, a gas fill socket 14 and a gas filter 15 are provided. By means of the gas fill socket 14 the tank 9 is refilled with the gas. By means of the pressure control valve it is ensured that the gas in the tank 9 is at the required pressure. The gas filter 15 ensures that no dirt particles reach the combustion chamber, respectively. During refilling, for example, by means of an appropriate valve, it is ensured that the gas to be refilled cannot pass into the common rail 11.

From the conduit 5 a transverse conduit 16 branches off in which an exhaust gas return valve 17 is seated. With it a portion of the exhaust gas can be supplied through the transverse conduit 16 to a supply conduit 18 in which the intake air is being supplied and by means of which the exhaust gas can be returned. The valve 17 is part of a return unit 19 with which, as is known in the art, a portion of the exhaust gas is admixed to the mixture of liquid and gaseous fuel in order to affect the combustion rate as well as to optimize the lambda value (air/fuel ratio). Since such return units 19 are known in the art, they will not be explained in detail in this context.

Aside from the unit 19, a turbocharger 20 is provided with which external air can be supplied, as is known in the art, to the combustion chambers of the internal combustion engine 1 by means of a downstream intermediate cooler as well as a downstream throttle valve 22. The supply of fresh air by means of the turbocharger 20 is realized by means of the same supply conduit 18 by means of which also a portion of the exhaust to gas is supplied by means of the unit 19,

With the aid of sensors 23 and 24 the pollutant contents in the exhaust gas passing through the conduit 5 is detected. For example, by means of the sensor 23; in the flow direction behind the catalyst 6, the HC contents and by means of the sensor 24, in the flow direction upstream of the catalyst 6, the O2 contents in the exhaust gas are detected. The measured values are supplied to a control unit 25 that, as is known in the art, controls the conditions in the combustion chambers of the internal combustion engine 1 in such a way that the values measured by the sensors 23; 24 are below or above predetermined legal limits.

For controlling the gas supply a separate control unit 26 is provided.

In the described device, the liquid fuel can be utilized together with the gaseous fuel but also independent therefrom. The part of the device provided for supplying gas can also be embodied as a conversion or retrofitting kit so that also existing internal combustion engines 1 can be furnished with the described technology. The device is suitable for cars, buses, trucks and the like. The conversion kit that will be explained in the following in more detail is comprised of simple components that not only can be produced inexpensively but also can be mounted easily.

From the supply conduit 18 the intake air passes into intake pipes 27 which supply the intake air to the combustion chambers. The intake pipes 27 are advantageously embodied as swirl pipes. The respective gas injector nozzle 12 is provided near one or both intake valves of the combustion chamber.

In one advantageous embodiment, the intake pipes 27 are designed such that the injector nozzle 12 enables, by asymmetric filling, a layered charging of the mixture of liquid fuel and air and the mixture of air and gaseous fuel so that an excellent uniform combustion of the mixture in the combustion chamber of the engine cylinder is achieved.

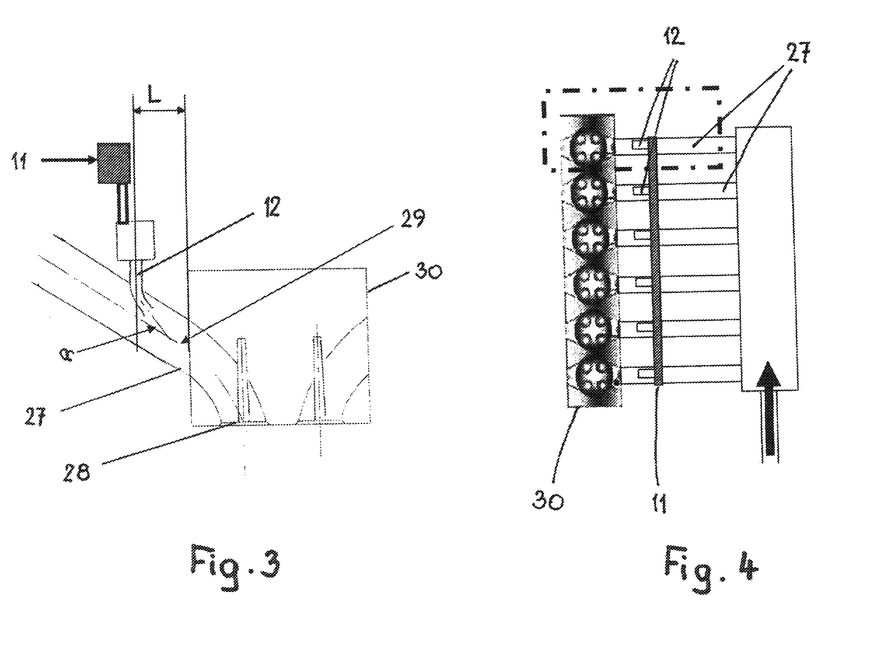

As shown in FIG. 3, the injector nozzle 12 opens near an inlet valve 28 in such a way into the intake pipe 27 that the gaseous fuel that exits from the injector nozzle 12 flows in the same direction as the intake air through the intake pipe 27. It can be seen that the mouth of the injector nozzle 12 is spaced from the longitudinal center axis 29 of the intake pipe 27. The free end of the injector nozzle 12 forms a gas injection pipe whose longitudinal axis together with the longitudinal center axis 29 of the intake pipe 27 defines an acute angle a.

The injector nozzle 12 is connected to the common rail 11. The spacing L between the axis of the injector nozzle 12 and the cylinder head 30 of the internal combustion engine is minimal.

FIG. 4 shows that advantageously all injector nozzles 12 are arranged eccentrically in relation to the intake pipe 27 and advantageously near the inlet valves of the combustion chambers of the internal combustion engine. The charge air or intake air is indicated by a flow arrow in FIG. 4.

The intake pipe 27 can be designed such that the injector nozzle 12 is arranged near one of the inlet valves of the respective combustion chamber (FIGS. 3 to 5).

In any case, the intake pipe 27 is designed such that an optimal mixture between the intake air, the exhaust gas, and the freshly supplied gas is enabled.

The intake pipe 27 is in any case designed such that an optimal mixing between the fresh gas and the returned exhaust gas by means of device 19 is ensured.

Depending on the application the intake pipes 11 can be heated or cooled.

The intake pipes 11 advantageously can be part of a module that can be used in conventional internal combustion engines, in particular in all 6, 8, 10, and 12 cylinder engines.

The pressure control valve 13 is advantageously mounted directly at the gas exit of the gas tank 9. In this context, the pressure control valve 13 is advantageously designed such that it can also served as a safety valve.

The pressure control valve 13 is actuated by mechanical and/or electrical signals in order to adjust the working pressure level. For this purpose, the pressure control valve 13 is connected to the control unit 26. The pressure control valve 13 is designed such that a predetermined pressure level of the gas is not surpassed. Advantageously, the control unit 26 controls the pressure control valve 13 such that the injection pressure into the combustion chambers of the engine 1 is adjusted to the load range in which the motor is operated.

When the pressure of the gas surpasses a predetermined value, the pressure control valve 13 can then prevent damage of the system. In one embodiment, in this case a safety valve is opened so that gas will be released at a gas pressure that is too high. In another embodiment, in such a critical situation the gas pressure in the working connector is regulated to zero by means of the pressure control valve 13.

With the pressure control valve 13 the injection pressure for the gaseous fuel can be adjusted for all operating states. Since the pressure control valve is connected to the control unit 26, with it the gas injection pressure can be controlled dependent on load, emissions or engine speed in order to obtain an optimally working internal combustion engine with emissions as low as possible. For example, with the control unit 26 an injection pressure between approximately 0 and approximately 50 bar can be adjusted.

The signals between the control unit 26 and the pressure control valve 13 can be transmitted wireless or by wire. The pressure control valve 13 can be connected by a bus system to the control unit 26. For a wireless data transmission, radio signals can be used, for example.

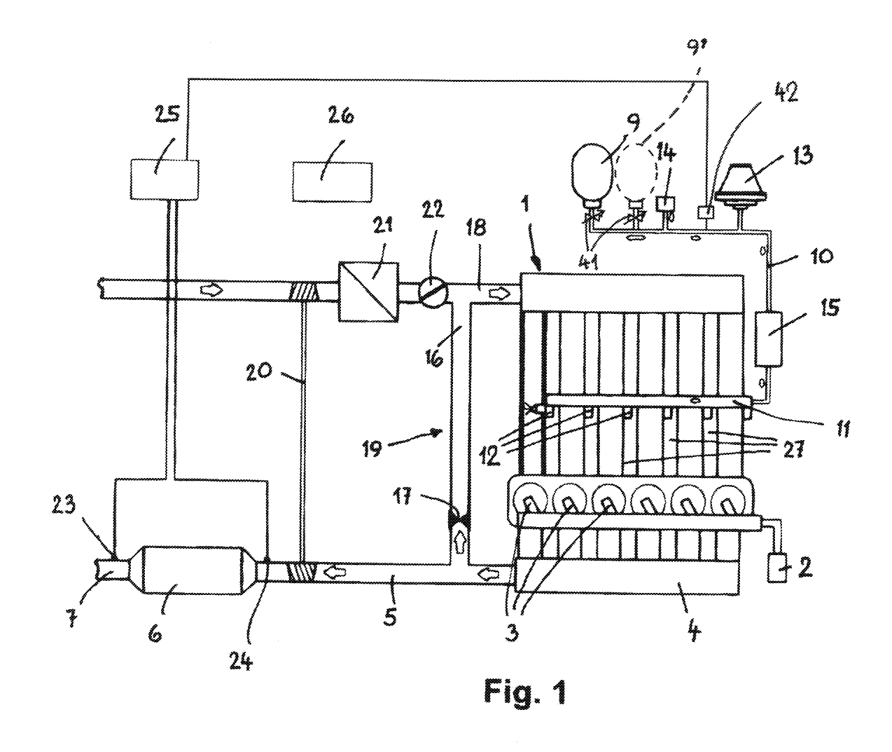

The gas tank 9 fulfills the safety requirements with regard to leakage safety and pressure safety. The gas tank 9 is provided with the at least one fill socket 14 that in FIG. 1 is illustrated adjacent to the gas tank only for the purpose of simplifying the illustration. By means of the at least one supply conduit 10 the gas tank 9 is in communication with the common rail 11.

The pressure control valve 13 can also be provided immediately on the gas tank 9 so that a simple and compact configuration results. Also, the gas tank 9 can contain all required sensors. So that it possible to detect easily from the exterior the pressure of the gas in the gas tank 9, it is provided advantageously with an appropriate pressure indicator.

The gas tank 9 can be designed such that it can receive more than one type of gas. The tank interior is appropriately provided with two or more chambers. In this case, the gas fill socket is advantageously designed such that combined filling with at least two gaseous fuels is enabled.

The walls of the gas tank 9 as well as, for a possible division into two or more chambers, the intermediate walls are of course designed such that the gaseous fuel cannot pass, in particular by diffusion, to the exterior or through the partitions into the neighboring chambers. The gas tank 9, depending of the embodiment, may contain natural gas, biogas or hydrogen.

The different gases can be mixed in the supply conduit 10 so that the gases are mixed when they reach the intake pipe 27, respectively.

In an embodiment that is not illustrated it is also possible to premix the different gases within the gas tank 9 and to then supply the gas mixture by means of supply conduit 10 to the intake pipe 27, respectively.

The different gases can also be contained in different gas tanks. In FIG. 1, for example, a further gas tank 9 is illustrated in dashed lines and is connected to the supply conduit 10. The two gas tanks 9, 9′ contain each a different gas. For example; the gas tank 9 can contain hydrogen and the gas tank 9′ can contain, for example, natural gas (CNG) or biogas.

The two gas tanks 9; 9′ each are connected by means of a control valve 41 to the supply conduit 10 By means of the control valve 41 the pressure at which the gas is flowing into the supply conduit 10 can be adjusted.

It is possible to introduce the gases from the gas tank 9, 9′ simultaneously into the supply conduit 10 so that already in the supply conduit the mixing of the two different gases is realized. The gas mixture passes then through the appropriate injector nozzle 12 into the intake pipe 27.

It is moreover possible to supply the different gases of the gas tanks 9, 9′ not simultaneously but alternatingly. In this case, depending on the predetermined application conditions, only one or the other gas we supplied to the intake pipe 27.

With a sensor 42, the gas or the gas mixture in the supply conduit 10 can be detected. The sensor 42 sends an appropriate signal to the control unit 25 that controls, as is known in the art, the conditions in the combustion chambers of the internal combustion engine 1 in such a way that the gas or gas mixture is supplied in the required quantity or mixing ratio.

The signal that is supplied from the sensor 42 to the control unit 25 can be used in particular for automatically selecting an engine characteristic map for this range that is saved within the control unit 25,

The retrofitting or conversion kit for the supply of gaseous fuel is designed such that it can be used for all gaseous fuels. Also, the retrofitting/conversion kit is provided with the required sensors that are suitable for all gaseous fuels.

The control unit 26 can be used also as a stand-alone unit. It is however also possible to use the control unit 26 as a slave unit in combination with the control unit 25 (master-slave principle). By means of the control unit 26 the degree of filling of the fuel device can be detected and the mixing ratio between the liquid and the gaseous fuel can be optimized as a function of the required motor performance. For this purpose, the performance characteristic line of the engine is utilized wherein also the emissions of CO₂, NOₓ or diesel particulate emission are taken into consideration which are measured by the appropriate sensors 23, 24 in the exhaust gas. The control unit 26 in this case is part of a control unit with which, as a function of the pollutant values measured by the sensors 23, 24, the optimal mixing ratio of liquid and gaseous fuel is adjusted such that the emissions values are below the prescribed legal limits.

By means of the control unit 26 it is also possible to determine whether the gas tank 9 contains a satisfactory quantity of gaseous fuel. For this purpose, the gas tank 9 is connected in an exemplary fashion by means of a fill level meter to the control unit 26. When an insufficient fill state of the gas tank 9 is detected, the control unit 26 ensures that the supply of the gaseous fuel is stopped and the operation of the internal combustion engine 1 is converted completely to liquid fuel. In this case, the internal combustion engine 1 is operated exclusively with liquid fuel until refilling of gaseous fuel is carried out.

The control units 25 and/or 26 can be designed advantageously such that, as needed, they supply diagnostics signals in order to perform servicing, repairs and the like.

The injector nozzles 3, 12 can be controlled together or alternatingly so that the supply of liquid or gaseous fuel can be realized at the same time or temporally in sequence. In this connection, the injection timing can be adjusted differently depending of the required mixing ratio.

The two control units 25, 26 interact with each other such that the liquid and the gaseous fuel are injected in the desired quantity into the respective combustion chambers of the cylinders.

By means of the control units 25, 26 it is also possible to adjust in addition an economic fuel consumption. In this way, not only an optimization with respect to the exhaust gas values but also with respect to the beneficial fuel consumption is realized. The liquid and/or gaseous fuel can be continuously but also sequentially injected into the combustion chambers. Advantageously, the injection is realized also in accordance with the oxygen proportion in a controlled fashion continuously or sequentially.

In the described way, it is thus possible to optimally adjust the supply of the respective fuel with respect to the emissions values and the fuel consumption for any operating point (engine speed/torque).

The control units 25, 26 can also be programmed such that the consumption of liquid and gaseous fuel is approximately identical so that both fuel types can be refilled at the same time.

Finally, programming also with regard to a large cruising range is possible. This point of consideration is for example important when the network of fuel stations is not very dense.

The disclosed embodiments show that the programming can be done with respect to different criteria, also in combination with each other.

The gaseous fuel is admixed to the intake air and the liquid fuel is directly injected. By means of the pre-injection of the liquid fuel the combustion is adjusted so that the main injection into the combustion chamber is then realized into already ignited gas.

By means of the control unit 26 it is possible to inject the gaseous fuel by means of one or several of the injector nozzles 12 into the combustion chambers in such a way that a layered charging in the combustion chambers is achieved. In this way, an excellent combustion of the mixture of liquid and gaseous fuel is ensured.

By means of the unit 19 is moreover possible to also return a portion of the exhaust gas by means of valve 17 and to add it to the mixture of liquid and gaseous fuel. This exhaust gas can be supplied to the injector nozzles 3 and/or the injector nozzles 12. By means of the proportion of returned exhaust gas a further variation possibility is provided in order to achieve an optimal operation of the internal combustion engine 1 at minimal emissions and minimal fuel consumption. In this connection, it is ensured that the combustion in the combustion chambers is performed optimally so that also wear of the mechanical parts of the internal combustion engine can be kept at a minimum.

The control units 25, 26 are designed such that at idle of the internal combustion engine 1 only the liquid or the gaseous fuel is injected into the combustion chambers. In particular, only one fuel is used when, for example, the hydrocarbon emissions surpass a predetermined value or the other emissions surpass or drop below permissible values.

In the described embodiment, the gaseous fuel is introduced from the gas tank 9 into the common rail 11 The gaseous fuel is supplied together with air to the common rail 11 so that by means of the intake pipes 27 connected to the common rail 11 a mixture of air and gaseous fuel passes into the respective cylinders. The air proportion is adjusted by means of the control unit 26 by means of which a throttle valve (not illustrated) for determining the air quantity can be controlled. The liquid fuel is injected advantageously directly into the combustion chamber after the mixture of air and gaseous fuel has been introduced. As a result of the high temperatures and the high pressure in the combustion chambers, the liquid fuel begins to combust so that also the gaseous fuel is combusted.

The proportion of liquid fuel can be replaced to up to approximately 60% by the gaseous fuel. Since the gaseous fuel is significantly more cost efficient than the liquid fuel, a significant savings with respect to fuel costs is achieved. In this context, the partial replacement of the liquid fuel by the gaseous fuel does not cause an impairment of the motor performance, of the torque as well as the service life of the internal combustion engine. The gaseous fuel is combusted very homogeneously.

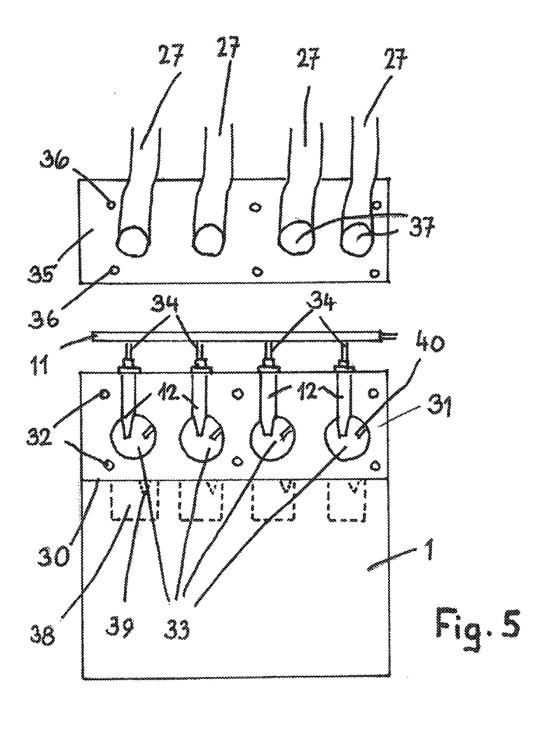

FIG. 5 shows schematically a retrofitting/conversion kit with which it is possible to retrofit or convert existing internal combustion engines in a very simple and inexpensive way. This retrofitting/conversion kit has a securing plate 31 that is attached seal-tightly to the cylinder heads 30 of the internal combustion engine 1. The securing plate 31 has through openings 32 for stud bolts that are projecting away from the cylinder heads 30. In the securing plate 31 there are passages 33 into which the injector nozzles 12 project. They are releasably secured in or on the securing plate 31 in a suitable way. The injector nozzles 12 are connected by means of conduits 34 to the common rail 11.

The securing plate 31 is designed as an intermediate flange that is attached between the cylinder heads 30 of the internal combustion engine 1 and a flange plate 35. It has also through openings 36 for the stud bolts of the cylinder heads 30. On the flange plate 35 the intake pipes 27 are attached. For passage of the intake air that is supplied by the intake pipes 27 the flange plate 35 is provided with appropriate passages 37.

The number of passages 33, 37 in the securing plate 31 as well as the flange plate 35 depends on the number of combustion chambers 38 of the internal combustion engine 1. They are shown in FIG. 5 only schematically without inlet and outlet valves. Illustrated is only an injector nozzle 39 for the liquid fuel that projects into the combustion chamber 38. The securing plate 31 and the flange plate 35 are resting against each other seal-tightly and can be mounted in a vary simple way on the cylinder heads 30. The intake pipes 27 are connected, as is known in the art, to the cylinder heads 30. As can be seen in FIGS. 3 and 4, the injector nozzles 12 project into the respective intake pipes 27. In FIG. 5, the intake pipes 27 and the injector nozzles 12 are illustrated separate from each other only for the purpose of simplifying the illustration.

The injector nozzles 12 are eccentrically positioned relative the passages 33 of the securing plate 31.

Advantageously, a sensor 42 with which the quality of the gaseous fuel can be detected can project into at least one of the passages 33. Advantageously, each passage 33 is provided with such a sensor 40.

The sensors 40 are connected to the control unit 26 and send signals that are characteristic of the quality of the gaseous fuel. The control unit 26, as a function of these sensor signals, can then determine the mixing ratio between gaseous and liquid fuel as well as intake air in such a way that optimal combustion of this mixture in the combustion chambers 38 can take place.

With the new device the EURO standards Ill to V can be achieved easily in diesel combustion engines. The NOₓ as well as the particulate emissions can be reduced by up to 50% wherein also the CO₂ emissions are significantly reduced.

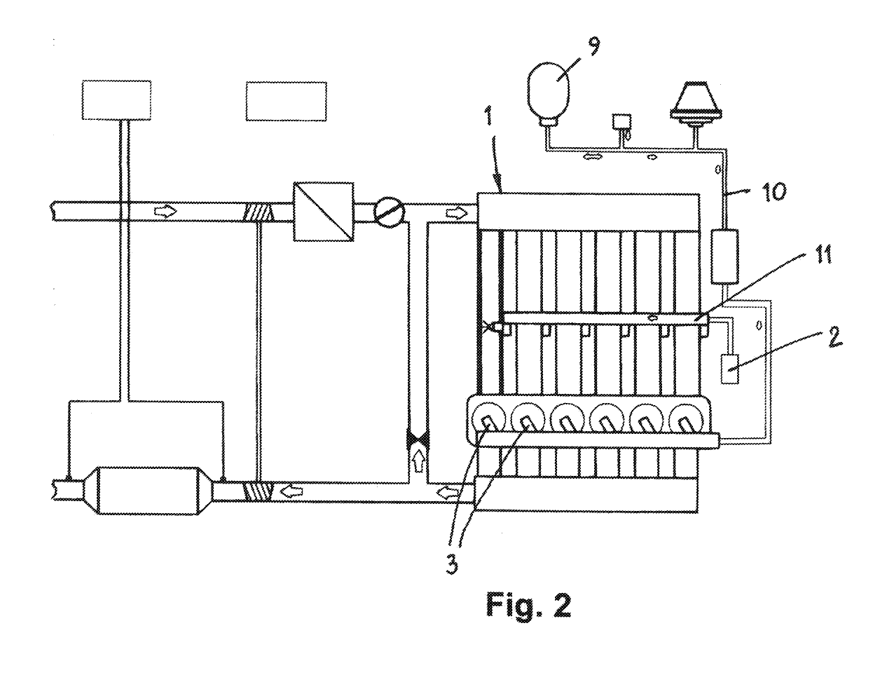

The embodiment according to FIG. 2 differs from the preceding embodiment substantially in that the supply of liquid and of the gaseous fuel is switched. The gaseous fuel is not injected into the common rail 11 but directly into combustion chambers by means of the valves 3. For this purpose, the liquid fuel is injected from tank 2 with low-pressure into the intake pipe. Such a procedure has the advantage that an expensive high-pressure gasoline pump as well as the expensive rail can be omitted. This embodiment is therefore excellently suitable for use in gasoline engines. As gaseous fuel advantageously natural gas (CNG) is used.

In such an embodiment also two or several gas tanks 9, an be provided that can be used in the same way as in the embodiment of FIG. 1.

In this embodiment, significant advantages are also provided for the vehicle driver, in particular cost-saving advantages, because the gaseous fuel is significantly less expensive than liquid fuel, especially gasoline. Moreover, for injecting the liquid fuel no expensive high-pressure pump and also no expensive high-pressure rail are required.

In comparison to an internal combustion engine that is operated exclusively with gaseous fuel, the mixed use of liquid and gaseous fuels provides savings of up to approximately 30%. In this connection, the performance and the torque of the internal combustion engine 1 in this mixed operation are higher than in single material operation where only the liquid or only the gaseous fuel is used.

The distribution of the liquid and of the gaseous fuel is advantageously adjusted to the load points. In this connection, the advantages of the fuel are utilized. The liquid fuel is characterized by its energy density and fast combustion. Therefore, the liquid fuel is preferably used for dynamic acceleration processes and at idle. At partial load and constant operating conditions the gaseous fuel is added The added proportion of the gaseous fuel is optimized for any operating point with respect to fuel consumption, CO₂ emissions and HC and NOₓ emissions. The operating points are operated with different injection pressures and optimized injection timing. At full load the gaseous fuel is injected as late as possible at high pressures. Since it is strongly cooled because of expansion from, for example, 220 bar in the gas tank 9 to approximately 8 to 30 bar, the mixture in the engine cylinder is cooled also.

Natural gas is characterized by a comparative octane rating of 130. Because of the cooler mixture and the high octane rating of the mixture, the compression ratio of the engine can be increased so that the full load torque is the same or higher and the fuel consumption is lower than in pure gasoline operation. Because of the greater compression ratio the partial load consumption is also improved. Because of the gas-liquid fuel mixture operation, the cruising range of the pure liquid fuel operation is maintained and the gas nozzles require a smaller mounting space that permits, for example, to replace the gasoline-gas nozzles with gas injector nozzles without great modifications in the engine.

Instead of gasoline, also methanol, ethanol or similar fuels can be used. Also, as a gaseous fuel, aside from natural gas, for example, also liquid gas (LPG), biogas, hydrogen and the like can be used.

In this embodiment, the internal combustion engine 1 can be operated also with only one type of fuel. It is therefore of no consequence whether during travel the liquid of the gaseous fuel is used up.

What is claimed is:

1.-13. (canceled)

14. An internal combustion engine with combustion chambers into which liquid and gaseous fuel is introduced together with intake air, wherein the internal combustion engine is operated, at least predominantly, with only one type of fuel in a range in which a harmful HC excess is produced by internal combustion.

15. The internal combustion engine according to claim 14, wherein the internal combustion engine when starting, when at idle, or when staring as well as at idle is operated with only one type of fuel or at least predominantly with only one type of fuel.

16. The internal combustion engine according to claim 15, wherein said one type of fuel is liquid fuel.

17. The internal combustion engine according to claim 14, wherein the internal combustion engine at full load range is operated with only one type of fuel or at least predominantly with only one type of fuel.

18. The internal combustion engine according to claim 14, wherein the internal combustion engine at full load is operated with liquid and gaseous fuel.

19. The internal combustion engine according to claim 14, wherein the internal combustion engine in a transient range is operated with only one type of fuel or at least predominantly with only one type of fuel.

20. The internal combustion engine according to claim 14, wherein the liquid fuel is diesel fuel and wherein the internal combustion engine, in the range in which a harmful HC excess is produced, is operated exclusively with the diesel fuel or at least predominantly exclusively with the diesel fuel.

21. The internal combustion engine according to claim 14, wherein the internal combustion engine is an Otto-cycle engine and the liquid fuel is gasoline, wherein the gasoline or the gaseous fuel is used as the sole fuel or at least predominantly as the sole fuel in a range in which upon mixed operation with gaseous fuel and gasoline a harmful HC excess is produced.

22. The internal combustion engine according to claim 14, wherein the liquid or gaseous fuel is injected eccentrically into an intake pipe or an intake channel near an inlet valve.

23. The internal combustion engine according to claim 14, wherein an injection of the gaseous fuel into the combustion chambers is realized near an inlet valve.

24. The internal combustion engine according to claim 14, comprising at least one pressure control valve that adjusts an injection pressure of the gaseous fuel to all operating states.

25. A retrofitting/conversion kit for an internal combustion engine according to claim 14, the kit comprising at least one securing plate for at least one injection nozzle for gaseous fuel, wherein a supply conduit for the gaseous fuel is connectable to the at least one injection nozzle, wherein the at least one securing plate is an intermediate flange to be connected between a cylinder head of the internal combustion engine and an intake manifold of the internal combustion engine.

26. The retrofitting/conversion kit according to claim 25, wherein the at least one injection nozzle is arranged eccentrically to a passage in the securing plate.

27. The retrofitting/conversion kit according to claim 25, comprising at least one sensor for detecting a quality of the gaseous fuel, wherein the at least one sensor projects into a passage of the securing plate.
